(19) United States
(12) Patent Application Publication
(10) Pub. No.: US 2025/0187691 A1
(43) Pub. Date: Jun. 12, 2025

(54) Bicycle wire-holding seat and a headset thereof

(71) Applicant: GLORY WHEEL ENTERPRISE CO., LTD., Taichung City (TW)

(72) Inventor: CHIEN-HAO LEE, Taichung City (TW)

(21) Appl. No.: 18/971,216

(22) Filed: Dec. 6, 2024

(30) Foreign Application Priority Data
Dec. 11, 2023 (TW) 112148132

(51) Int. Cl. B62J 11/19; B62K 19/32; B62K 21/06

(52) U.S. Cl. CPC B62J 11/19; B62K 19/32; B62K 21/06

(57) ABSTRACT

A bicycle wire-holding seat has an outer ring and a holding ring which is coaxially arranged with the outer ring and is applied to hold a bicycle tube. The outer ring and the holding ring form an inclined plane where they abut against each other. A wiring hole is formed between outer ring and the holding ring.

### FIELD OF INVENTION

The present invention is related to a bicycle accessory for cable routing and wiring, specifically a bicycle wire-holding seat and headset thereof.

### BACKGROUND OF THE INVENTION

It is general by using a control mechanism arranged near a handlebar to control shifting device and braking system of a bicycle, which may create a mechanical traction or an electronic signal transmitted via cables/wires. With the advancements of the technology, electric bicycles become more popular and tend to become customization, and demands for using the wires to connect and control various mechanisms of the bicycle are gradually increased.

However, it is difficult to avoid that the wires run through a bicycle frame may lead to damage while be pulled or rubbed against the vehicle frame when the handlebar is rotated, and this affects the quality and lifetime of the bicycle. Thus, producing a bicycle accessory that can achieve good wiring effects within the frame is an urgently needed in related industries.

### SUMMARY OF THE INVENTION

In order to produce a bicycle accessory which can achieve good wiring effects within the frame, the present invention provides a bicycle wire-holding seat, comprising an outer ring and a holding ring coaxially aligned with the outer ring along an axle, a first inclined plane arranged on the at least one part of an inner surface of the outer ring, a second inclined plane arranged on the at least one part of the outer surface of the holding ring and abut against to the first inclined plane, and a wiring hole formed between the outer ring and the holding ring extending along the axle, wherein the wiring hole is applied for receive a wire passing through and the holding ring is applied for holding one part of a frame of the bicycle.

Wherein, a slit is formed on the holding ring extending along the axle.

Wherein, the wiring hole is recessed in the inner surface of the outer ring or is in the outer surface of the holding ring.

Wherein, a stop portion applied for prevent the holding ring be displaced relative to the outer ring is arranged between the outer ring and the holding ring.

Wherein, the stop portion comprises a fixing rib protruded from the outer surface of the holding ring towards to the outer ring, and a fixing groove recessed in the inner surface of the outer ring, the fixing groove is applied for receive the fixing rib.

Wherein, the stop portion comprises a leaf extending radially from a surface of the ring, a position of at least one part of the leaf overlaps with the outer ring, a stopping rib protruded from at least one part of the leaf towards to the outer ring, and a stopping groove recessed in the surface of the outer ring aligning to the stopping rib, the stopping groove is applied for receive the stopping rib.

Wherein, the stop portion comprises a leaf extending radially from a surface of the ring, a position of at least one part of the leaf overlaps with the outer ring, a stopping hole penetrated at least one part of the leaf extending along the axle, and a stopping groove recessed in the surface of the outer ring aligning to the stopping hole, a pin mounted through the stopping hole and the stopping groove.

The present invention also provides a bicycle headset, comprising a bicycle wire-holding seat mentioned above and a bearing, and said wiring hole is misaligned with the bearing.

The bicycle wire-holding seat 10 can be stably installed in the frame 50, especially between a bicycle seat tube and a stand tube or between a head tube and a faucet or a faucet, and guide the wiring distribution of the wire A. In addition to achieving excellent wiring distribution to improve the quality and lifetime of the bicycle, organizing a placement of the wire A through the bicycle wire-holding seat 10 can improve the neatness of the working environment and the smoothness of the overall process during the manufacturing and assembly of the bicycle.

When the bicycle wire-holding seat is applied in the bicycle headset, the bicycle assembly can be designed to combine with a commercial bearing directly, achieving the effect of optimizing bicycles and improving industrial efficiency. Due to a co-rotation of the bicycle wire-holding seat and the bicycle headset, the wire can prevent from being pulled or rubbing against the bicycle frame when the faucet and/or the front fork is turn.

### BRIEF DESCRIPTION OF THE DRAWINGS

FIG. 1 is a perspective view of a first preferred embodiment of a bicycle wire-holding seat in accordance with the present invention;

FIG. 2 is a perspective view of a second preferred embodiment of a bicycle wire-holding seat in accordance with the present invention;

FIG. 3 is a cross-sectional perspective view of a third preferred embodiment of a bicycle wire-holding seat in accordance with the present invention;

FIG. 4 is an exploded perspective view of a fourth preferred embodiment of a bicycle wire-holding seat in accordance with the present invention; and

FIG. 5 is an exploded perspective view of a fifth preferred embodiment of a bicycle wire-holding seat in accordance with the present invention.

### DETAILED DESCRIPTION OF THE PREFERRED EMBODIMENTS

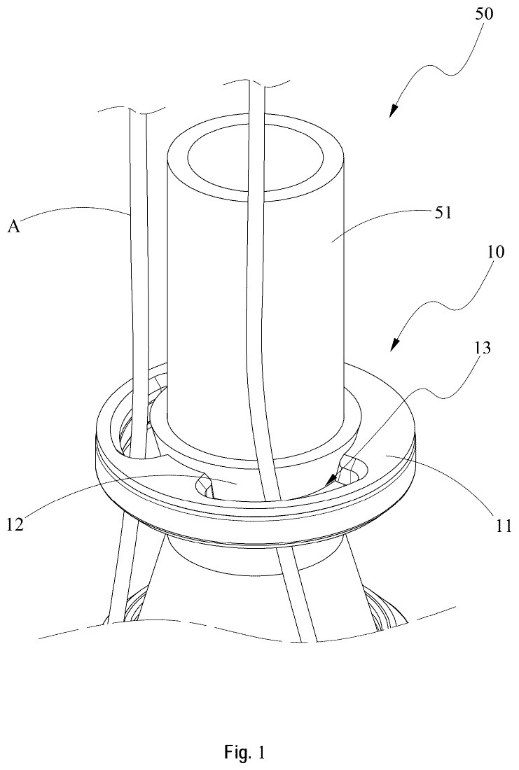

Referring to the FIGS. 1 to 4, a preferred embodiment of a bicycle wire-holding seat 10 in accordance with the present invention comprises an outer ring 11, a holding ring 12, and at least one wiring hole 13. The outer ring 11 is coaxially arranged around the holding ring 12 along an axial direction. At least one part of an outer surface of the holding ring 12 abuts against at least one part of an inner surface of outer ring 11. The at least one wiring hole 13 is formed between the outer ring 11 and the holding ring 12, and is applied for receive a wire A passing through.

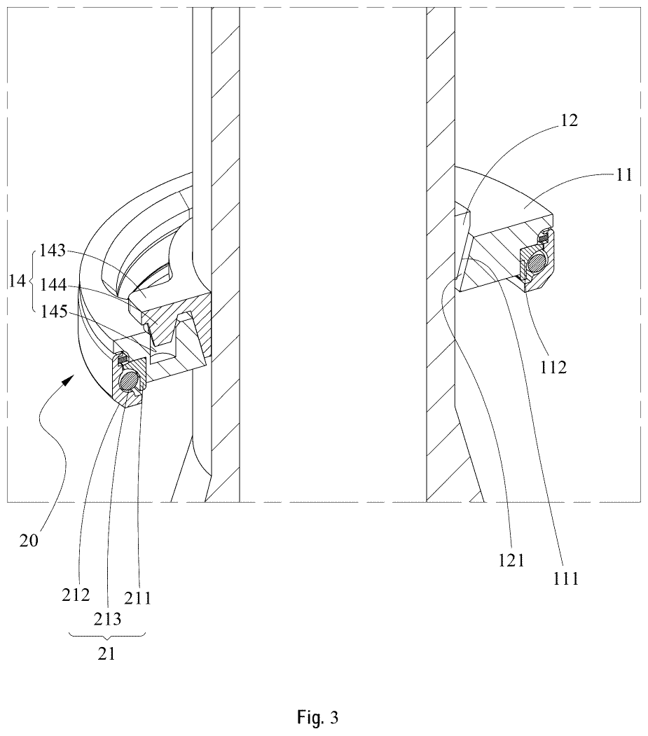

Preferably, with reference to FIG. 3, a first inclined plane 111 is arranged on the at least one part of the inner surface of the outer ring 11, and a second inclined plane 121 is arranged on the at least one part of the outer surface of the holding ring 12. The first inclined plane 111 and the second inclined plane 121 are inclined in the same direction, and the holding ring 12 can be inserted into the outer ring 11 to make the first inclined plane 111 and the second inclined plane 121 abut against each other.

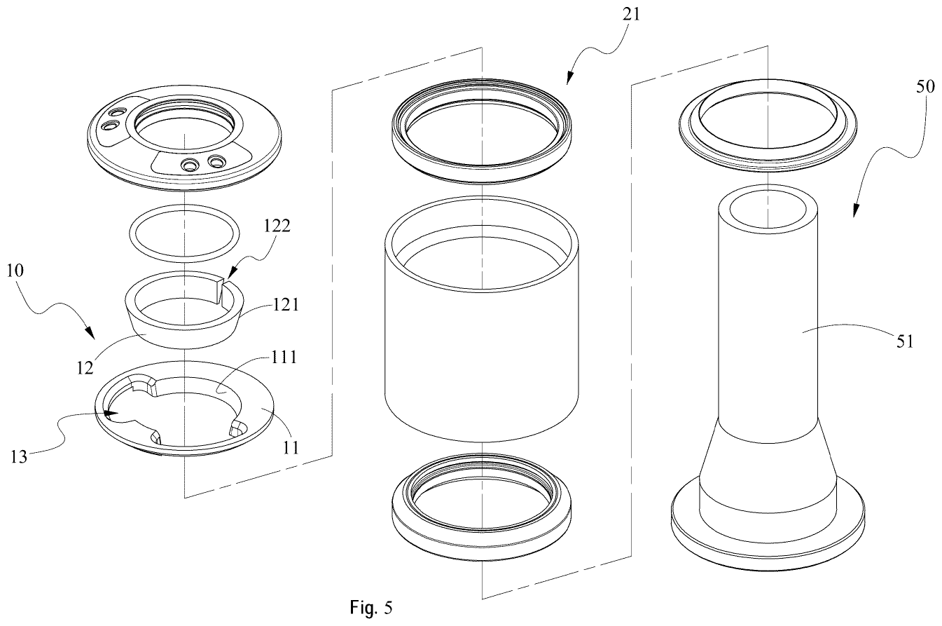

With referring to the FIG. 5, the bicycle wire-holding seat 10 may be preferably placed at a connection between two tubes of the bicycle, so that the holding ring 12 is allowed to clamp the outer surface of the inner tube 51.

Preferably, a slit 122 is formed in the holding ring 12 and extends along a longitudinal direction, and an inner diameter of the holding ring 12 can be changed according to the position relative to the outer ring 11. In the other word, as the holding ring 12 is inserted into the outer ring 11 with an outer diameter bigger than the inner diameter of the outer ring 11, the holding ring 12 is deformed due to the pressure from the outer ring 11, and the inner diameter of the holding ring 12 is reduced as the slit 122 closing. Thus, the inner diameter of the holding ring 12 can be adjusted to suit the size of the inner tube 51.

It is worth noting that in addition to be clamped by the holding ring 12, the inner tube 51 can be tightened and prevented from being detached or displaced relative to the bicycle wire-holding seat 10 by the pressure from the outer ring 11 when the holding ring 12 is inserted and combined with the outer ring 11.

In some embodiments, two wiring hole 13 are recessed in the inner surface of the outer ring 11.

In some embodiments, at least one wiring hole 13 is recessed in the outer surface of the holding ring 12.

A stop portion 14 is arranged between the outer ring 11 and the holding ring 12 and is applied for preventing the holding ring 12 from being displaced relative to the outer ring 11.

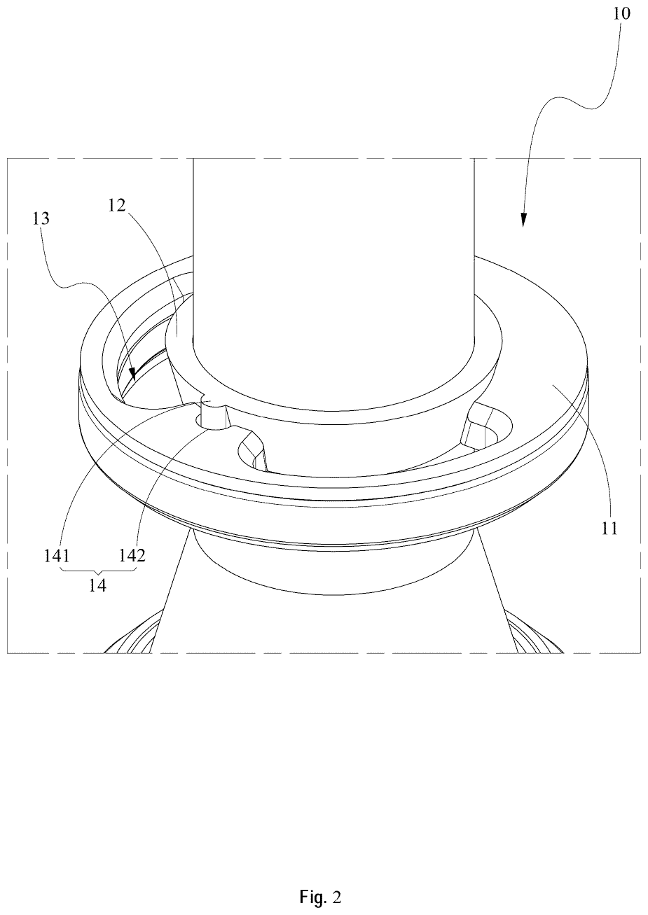

As shown in FIG. 2, the stop portion 14 comprises a fixing rib 141 protruded from the outer surface of the holding ring 12 towards the outer ring 11, and a fixing groove 142 is recessed in the inner surface of the outer ring 11. The fixing groove 142 holds the fixing rib 141 inside when the holding ring 12 and outer ring 11 are assembled with each other, so that the holding ring 12 is prevented from being rotated relative to the outer ring 11.

On the contrary, the fixing rib 141 may be arranged at the inner surface of t outer ring 11 towards the holding ring 12, and the fixing groove 142 may be recessed in the outer surface of the holding ring 12 to achieve a similar combination effect as mentioned above when the holding ring 12 and outer ring 11 are assembled with each other.

As shown in FIG. 3, in another embodiment, the stop portion 14 comprises a leaf 143 extending radially from a surface of the ring 12, and a position of at least one part of the leaf 143 overlaps with the outer ring 11. A stopping rib 144 protrudes from at least one part of the leaf 143 towards the outer ring 11, and a stopping groove 145 is recessed in the surface of the outer ring 11 to hold the stopping rib 144 inside. Thus, a rotation between the holding ring 12 and the outer ring 11 can be prevented, and the stopping rib 144 can also prevent an axial displacement between the outer ring 11 and the holding ring 12.

On the contrary, the leaf 143 and the stopping rib 144 may be arranged at the outer ring 11 towards the holding ring 12, and the stopping groove 145 may be recessed in the surface of the holding ring 12 to achieve a similar combination effect as mentioned above when the holding ring 12 and outer ring 11 are assembled with each other.

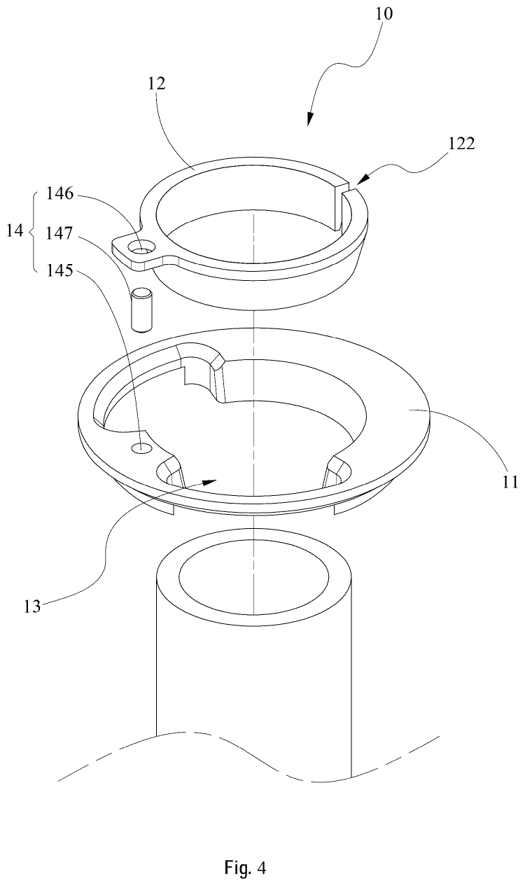

With referring to the FIG. 4, a difference from the above is that a stopping hole 146 is formed through at least one part of the leaf 143 along a longitudinal direction. Aligning the stopping hole 146 with the stopping groove 145 when the holding ring 12 and outer ring 11 are assembled with each other, then a pin 147 is inserted through the stopping hole 146 and into the stopping groove 145. Accordingly, the effect of to prevent the rotation and the axial displacement between the outer ring 11 and the holding ring 12 can be achieved.

The bicycle wire-holding seat 10 can be stably installed on the frame 50, especially between a bicycle seat tube and a stand tube or between a head tube and a faucet or a faucet to guide the wiring distribution of the wire A. In addition to achieving excellent wiring distribution to improve the quality and lifetime of the bicycle, organizing a placement of the wire A through the bicycle wire-holding seat 10 can improve the neatness of the working environment and the smoothness of the overall process during the manufacturing and assembly of the bicycle.

Furthermore, the bicycle wire-holding seat 10 provided by the present invention can also be applied in a bicycle headset 20 which is applied to allow a faucet and/or a front fork to rotate relative to a head tube. Referring to FIGS. 3 and 5, the bicycle headset 20 includes a bearing 21 comprising a first ring 211, a second ring 212 combined with the first ring 211 on the same axle, and multiple rolling elements 213 located between the first ring 211 and the second ring 212 to allow the first ring 211 to rotate relative to the second ring 212.

The outer ring 11, the holding ring 12, the first ring 211 and the second ring 212 are arranged coaxially, and one of the outer ring 11 or the holding ring 12 can be rotated with the first ring 211 or the second ring 212. The wiring hole 13 is misaligned with the bearing 21, which may allow the wire to extend through the wiring hole 13 without being blocked by the bearing 21. Due to a co-rotation of the bicycle wire-holding seat 10 and the bicycle headset 20, the wire A can be prevented from being pulled or rubbing against the bicycle frame when the faucet and/or the front fork is turn.

In the preferred embodiment, an annular groove 112 is recessed in the surface of the outer ring 11 opposite to the holding ring 12 and is applied to place the first ring 211 of the bearing 21 in the annual groove 112 to assemble the bicycle wire-holding seat 10 with the bearing 21. Thus, the bicycle assembly 10 of the present invention can be designed to combine with a commercial bearing 21 directly to achieve the effect of optimizing bicycles and improving industrial efficiency.

### SYMBOL EXPLANATION

bicycle wire-holding seat 10
outer ring 11
first inclined plane 111
annular groove 112
holding ring 12
second inclined plane 121
slit 122
wiring hole 13
stop portion 14
fixing rib 141
fixing groove 142
leaf 143
stopping rib 144
stopping groove 145
stopping hole 146
pin 147
bicycle headset 20
bearing 21
first ring 211
second ring 212
rolling element 213
frame 50
inner tube 51
outer tube 52
wire A

What is claimed is:

1. A bicycle wire-holding seat comprising an outer ring and a holding ring coaxially arranged with the outer ring, a first inclined plane arranged on at least one part of an inner surface of the outer ring, a second inclined plane arranged on at least one part of an outer surface of the holding ring and abutting against the first inclined plane, and a wiring hole formed between the outer ring and the holding ring extending, wherein the wiring hole is applied for receive a wire extending through the wiring hole and the holding ring is applied for holding one part of a frame of the bicycle.

2. The bicycle wire-holding seat as claimed in claim 1, wherein a slit is formed in the holding ring extending.

3. The bicycle wire-holding seat as claimed in claim 1, wherein the wiring hole is recessed in the inner surface of the outer ring or is in the outer surface of the holding ring.

4. The bicycle wire-holding seat as claimed in claim 2, wherein the wiring hole is recessed in the inner surface of the outer ring or is in the outer surface of the holding ring.

5. The bicycle wire-holding seat as claimed in claim 1, wherein a stop portion applied for preventing the holding ring from being displaced relative to the outer ring is arranged between the outer ring and the holding ring.

6. The bicycle wire-holding seat as claimed in claim 2, wherein a stop portion applied for preventing the holding ring from being displaced relative to the outer ring is arranged between the outer ring and the holding ring.

7. The bicycle wire-holding seat as claimed in claim 6, wherein the stop portion comprises a fixing rib protruding from the outer surface of the holding ring towards the outer ring, and a fixing groove recessed in the inner surface of the outer ring, and the fixing groove is applied for receive the fixing rib.

8. The bicycle wire-holding seat as claimed in claim 6, wherein the stop portion comprises a leaf extending radially from a surface of the ring, a position of at least one part of the leaf overlaps with the outer ring, a stopping rib protrudes from at least one part of the leaf towards the outer ring, a stopping groove is recessed in the surface of the outer ring, and the stopping groove is applied for receive the stopping rib.

9. The bicycle wire-holding seat as claimed in claim 6, wherein the stop portion comprises a leaf extending radially from a surface of the ring, a position of at least one part of the leaf overlaps with the outer ring, a stopping hole is formed in at least one part of the leaf, and a stopping groove is recessed in the surface of the outer ring and aligned with the stopping hole, a pin mounted through the stopping hole and the stopping groove.

10. A bicycle headset, comprising:
a bicycle wire-holding seat, comprising an outer ring and a holding ring coaxially arranged with the outer ring, a first inclined plane arranged on the at least one part of an inner surface of the outer ring, a second inclined plane arranged on the at least one part of the outer surface of the holding ring and abutting against the first inclined plane, and a wiring hole formed between the outer ring and the holding ring; and
a bearing arranged coaxially with the bicycle wire-holding seat and comprising a first ring and a second ring rotatable relative to the first ring, one of the outer ring or the holding ring can be rotated with the first ring or the second ring.

11. The bicycle headset as claimed in claim 10, wherein an annular groove is recessed in the surface of the outer ring opposite to the holding ring, the annular groove is applied for combine with the first ring.

12. The bicycle headset as claimed in claim 11, wherein the wiring hole is misaligned with the bearing.

13. The bicycle headset as claimed in claim 12, wherein the wiring hole is misaligned with the bearing.

14. A bicycle headset comprising a bicycle wire-holding seat provided in any one of claims 1 to 9 and a bearing, wherein the wiring hole is misaligned with the bearing.
